(19) United States
(12) Patent Application Publication
(10) Pub. No.: US 2006/0274212 A1
(43) Pub. Date: Dec. 7, 2006

(54) Method and apparatus for four-color data converting

(75) Inventors: Shin-Tai Lo, Miaoli County (TW); Ruey-Shing Weng, Kaohsiung City (TW)

Correspondence Address: BIRCH STEWART KOLASCH & BIRCH, PO BOX 747, FALLS CHURCH, VA, 22040-0747, US

(73) Assignee: WINTEK CORPORATION

(21) Appl. No.: 11/298,695

(22) Filed: Dec. 12, 2005

(30) Foreign Application Priority Data
Jun. 1, 2005 (TW) 094117941

(51) Int. Cl. H04N 9/64; H04N 9/78; H04N 9/74

(52) U.S. Cl. 348/650; 348/582; 348/651; 348/668

(57) ABSTRACT

A data converting for red, green, blue, and white four colors, after a pixel extracts a minimum value of red, green, and blue by using a minimum-value extractor to be the white light data value of the pixel converted to red, green, blue, and white four-color system; and then calculates a difference values among colors red, green, and blue of the pixel. The difference values of three colors are added to the neighboring pixels or sub-pixels such that at the same time when the red, green, blue, and white four-color system increases the luminance of the image color, the hue and saturation of the image color can be compensated adequately so that the image color can be very close to the situation of the original red, green, and blue three-color system.

### FIELD OF THE INVENTION

The present invention aims to convert the data values of the image color of the red, green, and blue three-color system to the data values of the image color of the red, green, blue, and white four-color system. By using a simple and easily implemented algorithm, it can supply the compensation effects of hue and saturation for the display quality of the panel.

### BACKGROUND OF THE INVENTION

The panel pixel is composed of four-color sub-pixels in recent years, besides the red (R), green (G), and blue (B) sub-pixels, there is white (W) sub-pixel. Under the requirement of high resolution for the display panel, the RGBW color system can offer the solution for higher luminance or lower power consumption. The arrangement of the sub-pixels red (R), green (G), blue (B), and white (W) are shown in FIGS. 1 and 2.

U.S. Pat. No. 5,929,843 discloses a method of RGB-to-RGBW image-data values converting and processing. The method is that the image-data values of the white color of the red-green-blue-white (RGBW) four-color system are equal to the minimum image-data value of the red-green-blue (RGB) three-color system. And the image-data values of red, green, and blue of the red-green-blue-white (RGBW) four-color system respectively equal to the image-data values of red, green, and blue of the red-green-blue three-color system. As shown in FIG. 3, where R, G, and B are input values of the image color, and R′, G′, B′ and W′ are output values of the image color, and a minimum-value extractor 11 that decides the value W′ for white (W) light to emit. The algorithm is as follows:
R′=R
G′=G
B′=B
W′=min(R,G,B)

The sub-pixel of a white light can increase ingredients of image colors red (R), green (G), and blue (B) at the same time, so the image luminance can be enhanced by the way of the above algorithm. However, the drawback of the algorithm is that the hue and saturation of the original image cannot be preserved. This is caused by that the increments of image colors red (R), green (G), and blue (B) are identical, which results in the change of the ratio among colors red (R), green (G), and blue (B) of the original image. The change can be understood by the following equation:
R:G:B≠(R′+W′):(G′+W′):(B′+W′)

Consequently, the hue and saturation of the image will be changed if the ratio among the original image colors red (R), green (G), and blue (B) is changed. The schematic diagram for color space is shown in FIG. 4. (For comparison, all schematic diagrams for color space are expressed as two-dimension (G, R) space). In FIG. 4, point A represents the original image color (RGB) while point A′ represents the resultant image color (R′G′B′) after the processing according to this algorithm. By observing FIG. 4, the path for converting point A to point A′ does not pass through the original point. Although the method proposed by patent U.S. Pat. No. 5,929,843 enhances the luminance, the hue and saturation of the original image cannot be preserved.

Although the method disclosed by U.S. Pat. No. 5,929,843 enhances the luminance, the hue and saturation of the original image cannot be preserved. For improving the drawback, U.S. Pat. No. 6,724,934 further discloses a new RGB-to-RGBW image-data values converting and processing method.

The method adopted by U.S. Pat. No. 6,724,934 is that classifying in advance according to the relation among data values of red (R), green (G), and blue (B) of the image pixel (assume that the maximum value of the gray level is 255). If the data are classified block B1, as shown in FIG. 5, point A1 represents the original image color (RGB) while point A1′ represents the resultant image color (R′G′B′) after the processing according to the algorithm. Converting point A1 to point A1′ not only increases luminance double but preserves hue and saturation of original colors. This is due to R:G:B=(R′+W′):(G′+W′):(B′+W′).

The algorithm is that (assume the maximum value of the gray level is 255) if min(2×R, 2×G, 2×B)<255, then
W′=min(2×R,2×G,2×B),
R′=2×R−W′,
G′=2×G−W′,
B′=2×B−W′.
If min(2×R, 2×G, 2×B)>255, then
W′=255,
R′=2×R−W′,
G′=2×G−W′,
B′=2×B−W′.

However, if the data are classified block B2, as shown in FIG. 6, after the numerical relation among red (R), green (G), and blue (B) data of the image pixel is classified, as shown in FIG. 6, point B represents the original image color (RGB) while point B′ represents the resultant image color (R′G′B′) after the processing according to the algorithm. Converting point B to point B′ not only increases luminance s-times (1≦s≦2) but preserves hue and saturation of original colors. This is due to R:G:B=(R′+W′):(G′+W′):(B′+W′). The algorithm is that (assume the maximum value of the gray level is 255) s=1+{min(R, G, B)/[max(R, G, B)−min(R, G, B)]}. If min(s×R, s×G, s×B)<255, then
W′=min(s×R,s×G,s×B),
R′=s×R−W′,
G′=s×G−W′,
B′=s×B−W′.
If min(2×R, 2×G, 2×B)>255, then
W′=255,
R′=s×R−W′,
G′=s×G−W′,
B′=s×B−W′.

Nevertheless, although the method disclosed by U.S. Pat. No. 6,724,934 not only increases luminance but preserves hue and saturation of original colors, the drawback of this algorithm is that the extents of increasing luminance for image colors (RGB) in block B1 and block B2 are different. The extent of increasing luminance for image color in block B1 is 2 while the extent of increasing luminance for image color in block B2 is s (where 1≦s≦2). Especially for those high-luminance and high-saturation images in block B2, of which the extents of increasing luminance are quite different from the extent of increasing luminance for image color in block B1. The extents of increasing luminance for those high-luminance and high-saturation images in block B2 approximate to 1, whereas the extent of increasing luminance for image color in block B1 is 2.

It results in an excessive variation of the simultaneous contrast, and the quality and effect of the image display are degraded. Especially when those images display high-luminance and high-saturation colors and high-luminance but tend to white color at the same time, the whole image quality is mostly degraded.

According to the aforementioned drawbacks, the Samsung Company proposed a paper named ‘Implementation of RGBW Color System in TFT-LCDs’ in the SID2004 conference. The paper depicted an Adaptive White Scaling (AWS) RGB-to-RGBW image-data values converting and processing algorithm.

Please refer to FIG. 7, at the same time of inputting the original image color (RGB), a prescribed luminance-enhancement gain w will be sent to the color distortion analyzer 22. The color distortion analyzer 22 will calculate the color-distortion value e for the image before and after the luminance enhancement according to the inputted original image color (RGB) data and the luminance-enhancement gain w. If the calculated color-distortion value e is greater than the critical value, the w controller 23 will lower the luminance-enhancement gain w, and a new luminance-enhancement gain w will be sent to the color distortion analyzer 22 to recalculate the color-distortion value e. Based on this loop, the process will continue until the color-distortion value e is smaller than the critical value. The luminance-enhancement gain w is sent to the RGBW converter 21 at this time.

Accordinngly, different image data (RGB) have different luminance-enhancement gains w so as to control the color-distortion value e before and after the luminance enhancement for different images to be lower than the critical value, and to restrain the phenomenon of too large variation of the simultaneous contrast before and after the luminance enhancement for some images.

However, the algorithm depicted in the paper has drawbacks as follows:
1. It is necessary to calculate the color-distortion value e before and after the luminance enhancement repeatedly so as to obtain the best luminance-enhancement gain w for the input image data (RGB). The method will cost complicated and mass investment for image calculation and hardware.
2. For dropping the color-distortion value e before and after the luminance enhancement, and improving the phenomenon of too large variation of the simultaneous contrast before and after the luminance enhancement, the Adaptive White Scaling (AWS) algorithm is achieved by dropping the luminance-enhancement gains w. In other words, although the quality of image display contrast is remedied, the effect of luminance enhancement needed by the system cannot be retained. Please refer to FIG. 8, which shows the color space that is displayed when the luminance-enhancement gain w is 2 (w=2). For dropping the color-distortion value e before and after the luminance enhancement, the luminance-enhancement gain w is dropped (as shown in FIG. 9). Even when those images display high-luminance and high-saturation colors and high-luminance but tend to white color, for the purpose of restraining the phenomenon of excessive variation of the simultaneous contrast after the luminance enhancement for images, the luminance-enhancement gain w is obligated to be dropped to 1 approximately (as shown in FIG. 10). As a result, the effect of promoting the color luminance of whole image is almost lost, and it is not able to achieve the goals of increasing luminance, preserving hue and saturation of colors, and preserving the image-contrast quality concurrently.

### SUMMARY OF THE INVENTION

Consequently, for solving the abovementioned problems, the main purpose of the current invention is to enhance the luminance of the displayed image color under the condition of retaining the hue and saturation of the original image.

Another purpose of the current invention is to overcome the phenomenon of excessive variation of the simultaneous contrast after the luminance enhancement for images so as to enhance the contrast quality and effect of the displayed image after the luminance enhancement.

The present invention has the third purpose that it will not cost complicated and much investment of hardware and image calculation, and it efficiently reduces the operation quantity of the image processing so as to save the investment for circuit hardware.

The present invention is the method and apparatus for four-color data converting. By adopting the minimum-value extractor to extract the minimum value of the original data value of a three-color light of a pixel to be the white data value after the pixel converts to the four-color system. A subtraction unit calculates the difference value of the pixel, and then the difference value output from the subtraction unit compensates the neighboring pixels. The pixel adds the difference value output from the neighboring pixels by an addition unit. By way of the space vision effect and color-sense effect of the neighboring pixels, when observing by human eyes, the pixel not only has the effect of increasing luminance, because of the compensation effect resulting from compensating the color-difference values to the neighboring pixels, but also improves changes of the hue and saturation due to lacking of those color-difference values.

### BRIEF DESCRIPTION FOR THE DRAWINGS

FIG. 1 is the schematic diagram for the well-known sub-pixel arrangement for the RGBW.

FIG. 2 is another schematic diagram for the well-known sub-pixel arrangement for the RGBW.

FIG. 3 is the schematic diagram for the image-processing method of U.S. Pat. No. 5,929,843.

FIG. 4 is the schematic diagram for the color space of U.S. Pat. No. 5,929,843.

FIG. 5 is the schematic diagram for the color space of U.S. Pat. No. 6,724,934. (The data are classified block one.)

FIG. 6 is the schematic diagram for the color space of U.S. Pat. No. 6,724,934. (The data are classified block two.)

FIG. 7 is the schematic diagram for the image-data value converting and processing proposed by the Samsung Company.

FIG. 8 is the schematic diagram for the color space of the image-processing method proposed by the Samsung Company. (w=2)

FIG. 9 is the schematic diagram for the color space of the image-processing method proposed by the Samsung Company. (w=1.6)

FIG. 10 is the schematic diagram for the color space of the image-processing method proposed by the Samsung Company. (w=1.2)

FIG. 11 is the schematic diagram for the calculation of the present invention.

FIG. 12 is the schematic diagram for the color space of the present invention.

FIG. 13 is the schematic diagram for compensating the color-difference values to unidirectional neighboring pixels on the one dimension of the present invention.

FIG. 14 is the schematic diagram for compensating the color-difference values to bidirectional neighboring pixels on the one dimension of the present invention.

FIG. 15 is the schematic diagram for compensating the color-difference values to bidirectional neighboring pixels on the two dimension of the present invention.

FIG. 16 is the schematic diagram for compensating the color-difference values to all neighboring pixels that surround the pixel of the present invention.

FIG. 17 is the schematic diagram for compensating the color-difference values to all neighboring sub-pixels that surround the pixel of the present invention.

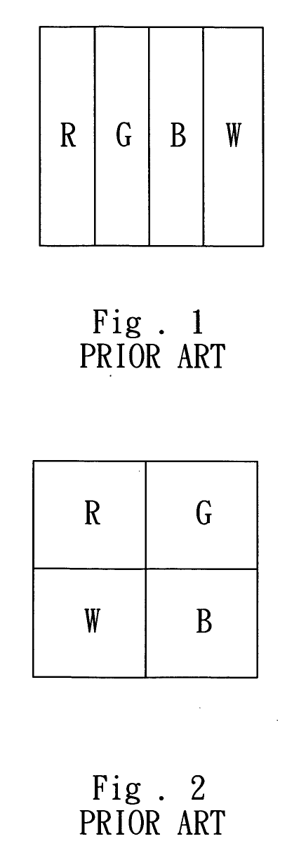

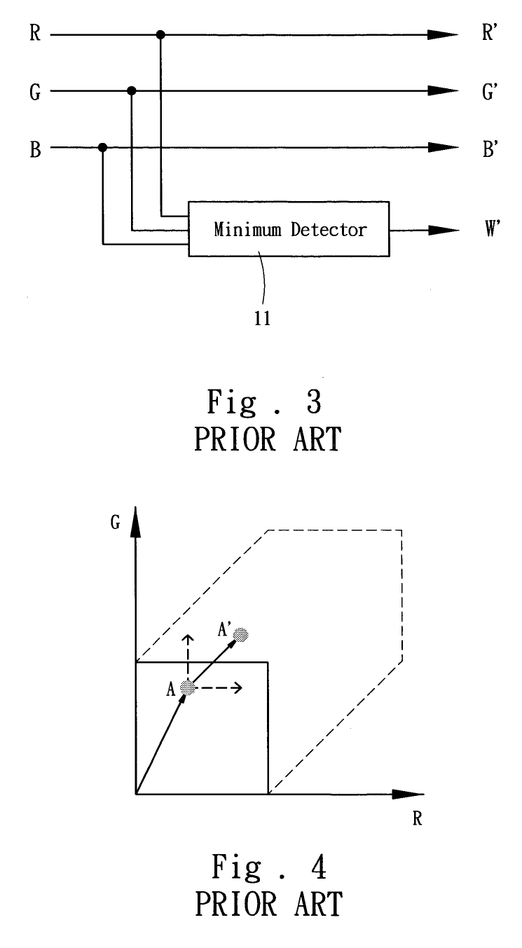

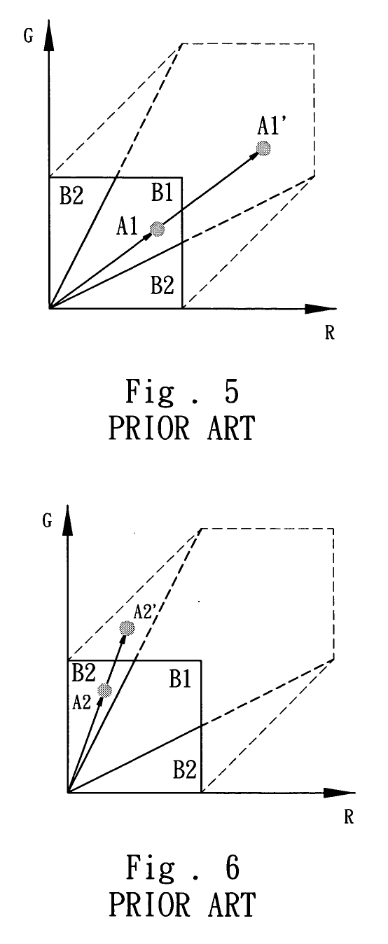

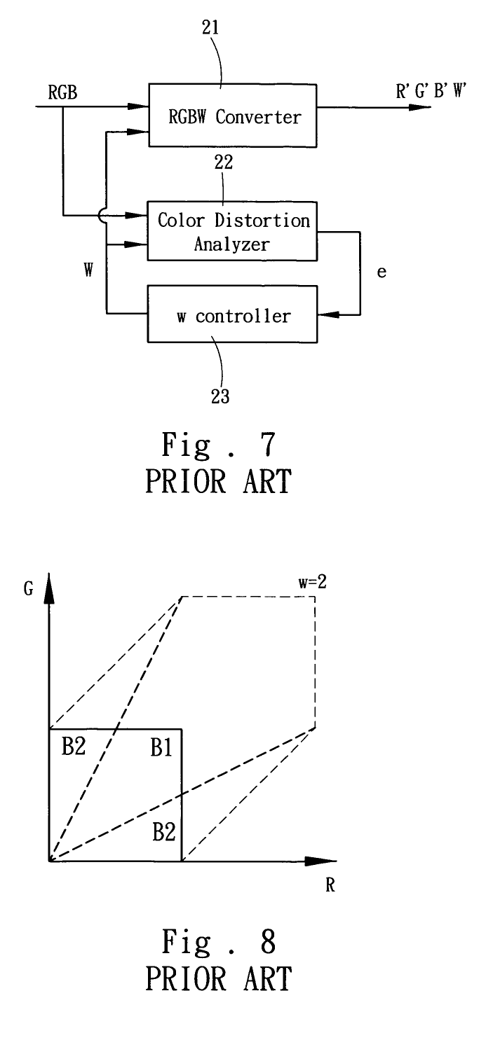

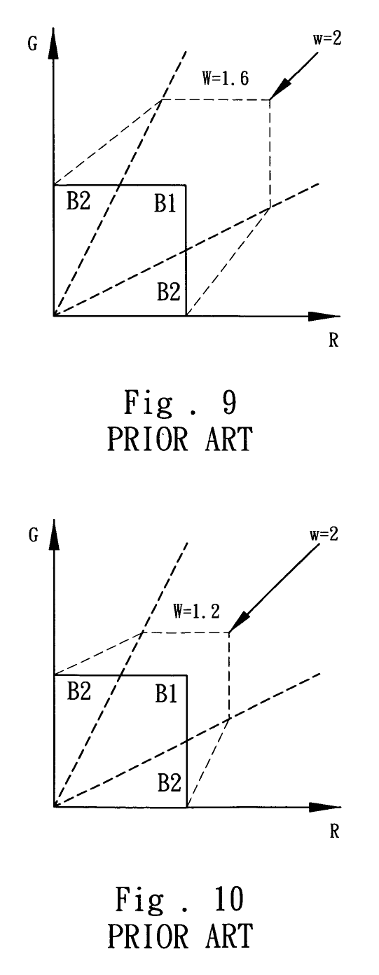

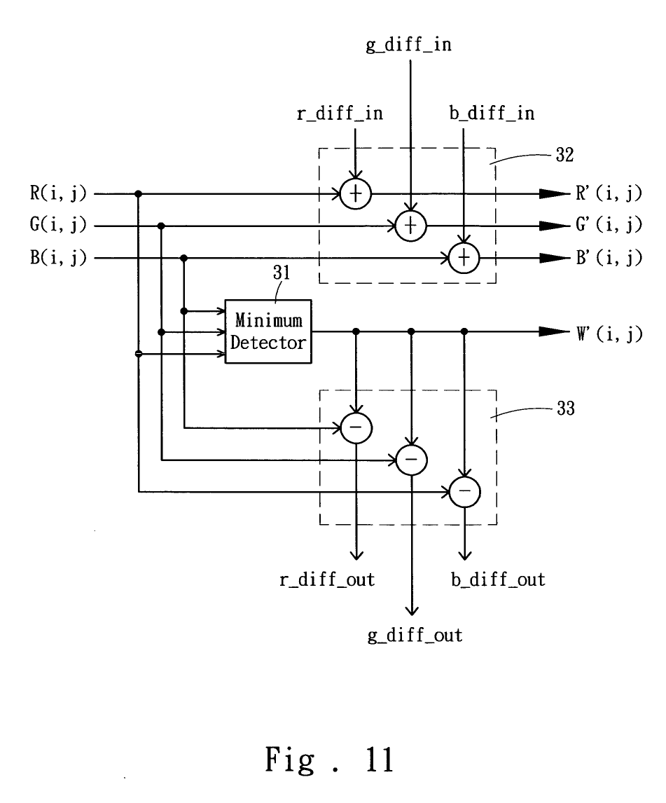

### DESCRIPTION OF THE PREFERRED EMBODIMENT

The detailed descriptions for content and technology of this invention associate with figures are as follows.

Please refer to FIG. 11, which is the schematic diagram for the calculation of the present invention.

A minimum-value extractor 31 is used to receive the data of the three original colors R(i,j) G(i,j) B(i,j) of the pixel, and to extract the minimum value min(r, g, b) to be the white color data value w of the pixel.

A subtraction unit 33 is used to calculate color-difference values r_diff, g_diff, and b_diff, wherein the color-difference values r_diff, g_diff, and b_diff are obtained by subtracting the white color data value w from the data r, g, b of the three original colors R(i,j) G(i,j) B(i,j) of the pixel, respectively. And then the color-difference values (r_diff, g_diff, and b_diff) output from the subtraction unit 33 compensates the neighboring pixels.

An addition unit 32 is used to add the color-difference values output from the neighboring pixels to the data values of the three original colors R(i, j) G(i, j) B(i, j) of the pixel so as to form another data values of the three colors R′(i, j) G′(i, j) B′(i, j) output from the pixel.

The way for mending the color-difference values to the neighboring pixels is that when there is a pixel of the red R(i, j), green G(i, j), and blue B(i, j) three-color system and the original data values of colors red R(i, j), green G(i, j), and blue B(i, j) of the pixel are r, g, and b, by using the minimum-value extractor 31 to extract the minimum value of the red R(i, j), green G(i, j), and blue B(i, j) of the pixel to be the data value w of the white color W′ (i, j) after the pixel converts from the three-color system to the four-color system of red R′(i, j), green G′(i, j), blue B′(i, j), and white W′(i, j), wherein w=min(r, g, b).

Because the white color portion W′(i, j) of the color performance of the red R′(i, j), green G′(i, j), blue B′(i, j), and white W′(i, j) four-color system can be treated as increasing the same extent to the ingredients of the red R(i, j), green G(i, j), and blue B(i, j) three-color light of the pixel, the increment is the data value w of the white color W′ (i, j). Therefore, the effective values of the ingredients of the three-color light after conversion are
Red=r+w,
Green=g+w,
Blue=b+w,

In which, if the effective values of the three-color light emitted by the red R′(i, j), green G′(i, j), and blue B′(i, j) of the pixel are required to be the double of the original data values r, g, and b of the original red R(i, j), green G(i, j), and blue B(i, j) three-color light system, then the deficient values in the three colors are
r_diff=r−w,
g_diff=g−w,
b_diff=b−w, respectively.

The deficient values in the three colors (r_diff, g_diff, and b_diff) are defined as the difference values of red R′(i, j), green G′(i, j), and blue B′(i, j) of the pixel. At least one color-difference value among the three color-difference values of red R′(i, j), green G′(i, j), and blue B′(i, j) is zero, because at least one of the original data values r, g, and b of the original red R(i, j), green G(i, j), and blue B(i, j) three-color light equals the white data value w (due to w=min(r, g, b)).

After the minimum-value extractor 31 extracts the minimum value of the original data values r, g, and b of the original red R(i, j), green G(i, j), and blue B(i, j) three-color light to be the data value w of the white color W′ (i, j) after the pixel converts to the red R′(i, j), green G′(i, j), blue B′(i, j), and white W′(i, j) four-color system, and then the subtraction unit 33 calculates color-difference values of the red R′(i, j), green G′(i, j), and blue B′(i, j) of the pixel, where the color-difference values r_diff, g_diff, and b_diff are obtained by subtracting the white color data value w from the data r, g, b of the three original colors R(i, j) G(i, j) B(i, j) of the pixel, respectively.

Mending these three color-difference values r_diff, g_diff, and b_diff to the data values of the three-color light (R′G′B′) of the neighboring pixels through color-difference values r_diff_out, g_diff_out, and b_diff_out output from the subtraction unit 33.

The pixel accepts the color-difference values r_diff_in, g_diff_in, and b_diff_in passed from the neighboring pixels via the calculation of the addition unit 32 to form a configuration that compensates difference values to each other. By way of the space-vision effect of the neighboring pixels, when observing by human eyes, the pixel not only has the effect of increasing luminance because of the compensation effect in space resulting from compensating the color-difference values to the neighboring pixels, but also improves changes of the hue and saturation due to lacking of those color-difference values. Hence, the goals of compensating the hue and saturation of the image color are achieved, and an approach by mending color-difference values to the neighboring pixels is formed.

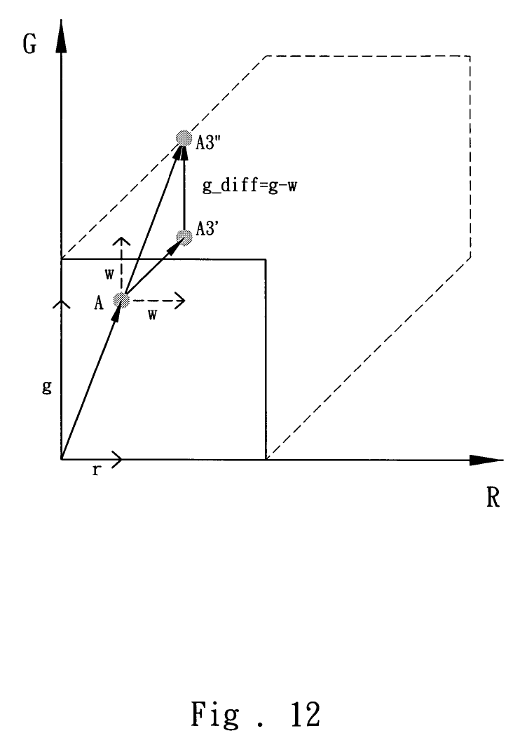

Now, the color space diagram for colors red (R) and green (G) is employed for demonstration, as shown in FIG. 12. Point A3 represents the original image color, A3′ represents the image color that has been processed by the well-known algorithm Red=r+w, Green=g+w, Blue=b+w (where w=min(r, g, b)). Although the image luminance can be enhanced by way of the above algorithm, the hue and saturation of the original image cannot be preserved. Point A3″ represents the equivalent image color of point A3′ which has been processed of mending the color-difference values by the neighboring pixels. The figure takes min(r, g, b)=r as an example, the color-difference value of the pixel is g_diff=g−w. According to the scale of the difference between the data values of the neighboring pixels is not large, the mended color-difference value of the pixel g_diff is also equal to (g−w) approximately. Accordingly, this invention not only increases the luminance by using the red, green, blue, white (RGBW) four-color system but also compensates the possible changes of the hue and saturation in the luminance-increasing process by way of an algorithm.

In which, the configuration of mending the color-difference values to the neighboring pixels is a unidirectional neighboring pixels on the one-dimension of the pixel (as shown in FIG. 13). In other words, the direction of compensating the color-difference value for a single pixel on the display panel aims to compensate the color-difference value to the unidirectional (which includes the left, right, up, or down) neighboring pixels on the one-dimension of the pixel.

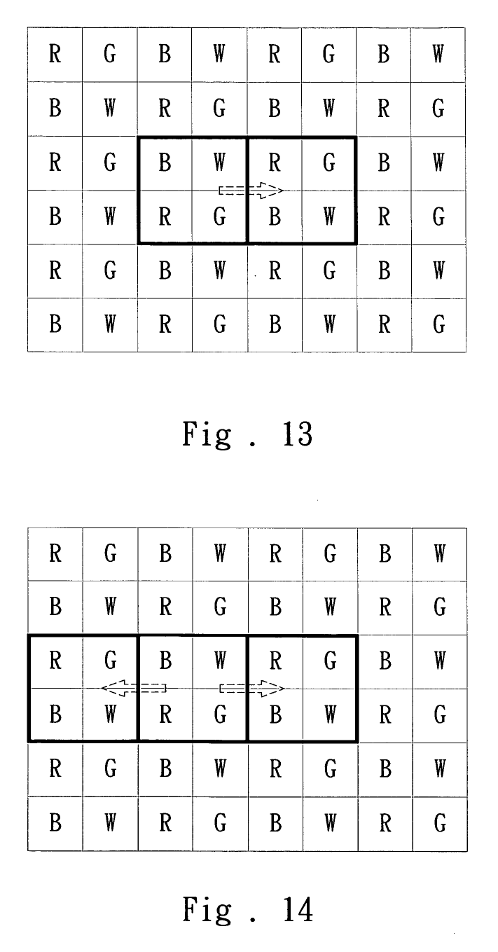

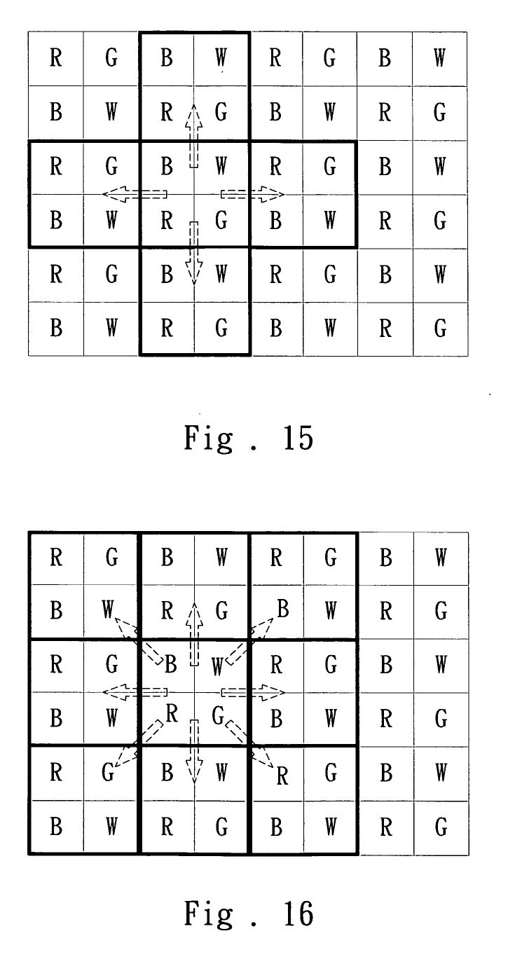

Or, the configuration of mending the color-difference values to the neighboring pixels is a bidirectional neighboring pixels on the one-dimension of the pixel (as shown in FIG. 14). In other words, the direction of compensating the color-difference value for a single pixel on the display panel aims to equally compensate the color-difference value to the bidirectional (which includes the left and right, or up and down) neighboring pixels on the one-dimension of the pixel.

Or, the configuration of mending the color-difference values to the neighboring pixels is a bidirectional neighboring pixels on the two-dimension of the pixel (as shown in FIG. 15). In other words, the direction of compensating the color-difference value for a single pixel on the display panel aims to equally compensate the color-difference value to the bidirectional (which includes the left, right, up and down) neighboring pixels on the two-dimension of the pixel.

Or, the configuration of mending the color-difference values to the neighboring pixels is all neighboring pixels that surround the pixel (as shown in FIG. 16). In other words, the direction of compensating the color-difference value for a single pixel on the display panel aims to equally compensate the color-difference value to the neighboring pixels (which includes the left, right, up, down, and the directions of oblique angles totally eight neighboring pixels) of the pixel.

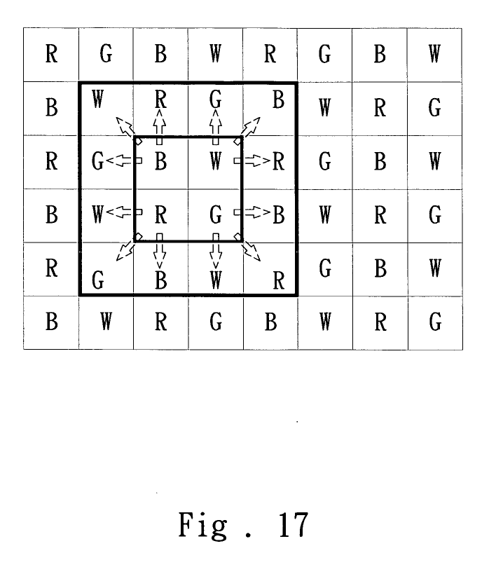

Or, the configuration of mending the color-difference values to the neighboring pixels is all neighboring sub-pixels that surround the pixel (as shown in FIG. 17). In other words, the direction of compensating the color-difference value for a single pixel on the display panel aims to equally compensate the color-difference value to the neighboring sub-pixels (which includes the left, right, up, down, and the directions of oblique angles totally eight neighboring pixels) of the pixel.

This invention uses a simple and easily implemented algorithm and the algorithm provides sufficient compensation effect for the qualities of hue and saturation to make the ratio of the actual red, green, and blue (RGB) three colors of the image color of the red, green, blue and white (RGBW) four-color system as close to the ratio of the red, green, and blue (RGB) three colors of the image color of the original red, green, and blue (RGB) three-color system as possible. Meanwhile, many complicated calculations for image data are avoided so as to save the circuit area and operation time for image process.

This invention uses the method that adds the color-difference values to the neighboring pixels such that at the same time when the red, green, blue, and white (RGBW) four-color system increases the luminance of the image color, the hue and saturation of the image color can be compensated adequately so that the image color can be very close to the situation of the original red, green, and blue three-color system. And the method that adds the color-difference values to the neighboring pixels, mentioned in this invention, uses only addition and subtraction in the algorithm, which immensely reduces the operation complexity. Consequently, the required circuit area and operation time are reduced, which very satisfies the requirements of small-dimension and low-cost for display panels.

To sum up, comparing the data-converting method proposed by this invention with well-known image data process method, this invention has the following merits:
1. Under the condition of increasing the display luminance of the original image color, this invention preserves the hue and saturation of the image color.
2. For converting the data values of the image color of the red, green, and blue (RGB) three-color system to the data values of the image color of the red, green, blue, and white (RGBW) four-color system, the present invention proposed a simple algorithm whereas the algorithm provides sufficient compensation effect for the hue and saturation so as to save the circuit area and operation time for image process.

However, the above description is only a better practice example for the current invention, which is not used to limit the practice scope of the invention. All equivalent changes and modifications based on the claimed items of this invention are in the scope of the present invention.

What is claimed is:

1. A method for four-color data converting, comprising:
using a minimum-value extractor to extract a minimum value of original three-color data values of a pixel to be a data value of white color of the pixel;
a subtraction unit calculating a color-difference value of the pixel, and then outputting the color-difference value from the subtraction unit to compensate the neighboring pixels; and
at the same time, an addition unit receiving the color-difference values output from the neighboring pixels, and adding the color-difference values to the data values of the three original colors of the pixel so as to form another data values of the three original colors output from the pixel.

2. The method as claimed in claim 1, wherein the color-difference values are obtained by respectively subtracting the white color data value from the data values of the three original colors of the pixel.

3. The method as claimed in claim 1, wherein the neighboring pixels are unidirectional neighboring pixels on the one dimension.

4. The method as claimed in claim 1, wherein the neighboring pixels are bidirectional neighboring pixels on the one dimension.

5. The method as claimed in claim 1, wherein the neighboring pixels are bidirectional neighboring pixels on the two-dimension.

6. The method as claimed in claim 1, wherein the neighboring pixels are the neighboring pixels that surround the pixel.

7. The method as claimed in claim 1, wherein compensating the neighboring pixels is to compensate all sub-pixels of the neighboring pixels that surround the pixel.

8. An apparatus for four-color data converting, comprising:
a minimum-value extractor, which is used to receive data values of three original colors, and to extract a minimum value of original three-color data values of a pixel to be the data value of white color of the pixel;
a subtraction unit, which is used to calculate a color-difference value of the pixel, and then outputs the color-difference value from the subtraction unit to compensate the neighboring pixels;
an addition unit, which is used to add the color-difference values output from the neighboring pixels to the data values of the three original colors of the pixel so as to form another data values of the three original colors output from the pixel.

9. The apparatus as claimed in claim 8, wherein the color-difference values are obtained by respectively subtracting the white color data value from the data values of the three original colors of the pixel.

10. The apparatus as claimed in claim 8, wherein the neighboring pixels are the unidirectional neighboring pixels on the one-dimension.

11. The apparatus as claimed in claim 8, wherein the neighboring pixels are the bidirectional neighboring pixels on the one-dimension.

12. The apparatus as claimed in claim 8, wherein the neighboring pixels are the bidirectional neighboring pixels on the two-dimension.

13. The apparatus as claimed in claim 8, wherein the neighboring pixels are the neighboring pixels that surround the pixel.

14. The apparatus as claimed in claim 8, wherein compensating the neighboring pixels is to compensate all sub-pixels of the neighboring pixels that surround the pixel.
